(19) United States
(12) Patent Application Publication
(10) Pub. No.: US 2008/0295323 A1
(43) Pub. Date: Dec. 4, 2008

(54) CIRCUIT BOARD ASSEMBLY AND METHOD OF MANUFACTURING THE SAME

(75) Inventor: FU-YEN TSENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/862,495

(22) Filed: Sep. 27, 2007

(30) Foreign Application Priority Data
Jun. 4, 2007 (CN) 200710200753.7

(51) Int. Cl. H01R 43/00

(52) U.S. Cl. 29/825

(57) ABSTRACT

An exemplary circuit board assembly includes a circuit board, at least one conductor, and a reinforcing board. The circuit board has at least one hole formed therein. Each conductor is received in one respective hole. The reinforcing board is attached to the circuit board and is electrically connected to the circuit board via the at least one conductor. The present invention also relates to a method of making the circuit board assembly.

### TECHNICAL FIELD

The present invention relates to circuit board assemblies and, particularly, to a circuit board assembly with electromagnetic interference shielding, and a method making the circuit board assembly.

### BACKGROUND

At present, various electronic devices, and in particular mobile electronic devices, must be able to withstand a variety of physical and environmental stresses. Many electronic devices include substrates which support circuitry. One common form of a substrate is a circuit board, such as a printed circuit board (PCB). Although PCBs are typically contained within a housing of the electronic device, the PCBs can still experience electromagnetic interference in a variety of situations. Thus, it is highly desirable to provide electromagnetic (EMI) interference shielding for the circuit board.

FIG. 8 illustrates a typical circuit board assembly 60. The circuit board assembly 60 includes a circuit board 62, a reinforcing board 63 (referred to as stiffener), and a conductive bonding layer 64 interposed between the circuit board 62 and the reinforcing board 63. The circuit board 62 includes two insulating layers 69 and a circuit pattern layer 65 sandwiched between the two insulating layers 69. The reinforcing board 63 is adhered to one of the two insulating layer 69 of the circuit board 62 via the conductive bonding layer 64. The adhered insulating layer 69 defines a blind hole 67, which a projection 66 of the conductive bonding layer 64 extends into. Accordingly, the conductive bonding layer 64 forms an electrical connection between the circuit pattern layer 65 and the reinforcing board 63.

In the circuit board assembly 60, the conductive bonding layer 64 typically includes particles or fibers. However, the particles and fibers have low temperature resistance. Thus, during heating of solder of the circuit board 62, resistance of the conductive bonding layer 64 would be undesirably increased and conductivity thereof would be decreased. This hinders electrical conduction between the circuit board 65 and the reinforcing board 63. Thus, the circuit board assembly 60 cannot form an effective shield against EMI.

What is needed, therefore, is a circuit board assembly that has an effective shield against EMI.

What is needed, also, is a method of manufacturing the circuit board assembly.

### SUMMARY

In accordance with a preferred embodiment, a circuit board assembly includes a circuit board, at least one conductor, and a reinforcing board. The circuit board has at least one hole formed therein. The at least one conductor essentially consists of metal. The at least one conductor is received in the at least one hole. The reinforcing board is attached to the circuit board and is electrically connected to the circuit board via the at least one conductor.

A method of making a circuit board assembly includes steps of: providing a circuit board and a reinforcing board, the circuit board having at least one hole formed therein, at least one solder being received in the at least one hole, the at least one solder essentially consisting of metal, the reinforcing board being attached to the circuit board with the at least one hole facing towards the reinforcing board; and heating and sequentially cooling the solder to form a conductor electrically connecting the circuit board to the reinforcing board.

Other advantages and novel features will be drawn from the following detailed description of preferred embodiments when considered in conjunction with the attached drawings.

### BRIEF DESCRIPTION OF THE DRAWINGS

Many aspects of the present circuit board assembly can be better understood with reference to the following drawings. The components in the drawings are not necessarily drawn to scale, the emphasis instead being placed upon clearly illustrating the principles of the present circuit board assembly. Moreover, in the drawings, like reference numerals designate corresponding parts throughout the several views.

FIG. 1 is a schematic, cross-sectional view of a circuit board assembly, according to a first preferred embodiment;

FIG. 2 is a schematic, plan view of a bonding layer attached on a circuit board of the circuit board assembly of FIG. 1;

FIG. 3 is a flow chart of a manufacturing method of the circuit board assembly of FIG. 1;

FIG. 4 is a schematic, cross-sectional view of another circuit board assembly, according to a second preferred embodiment;

FIG. 5 is a flow chart of a manufacturing method of the circuit board assembly of FIG. 4;

FIG. 6 is a schematic, cross-sectional view of an alternative circuit board assembly, according to a third preferred embodiment;

FIG. 7 is a schematic, cross-sectional view of another alternative circuit board assembly, according to a fourth preferred embodiment; and

FIG. 8 is a schematic, cross-sectional view of a conventional circuit board assembly.

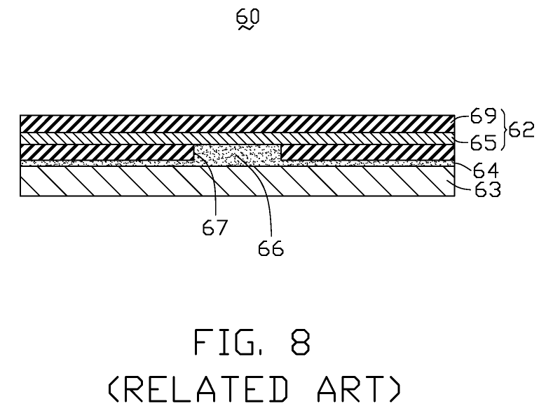

### DETAILED DESCRIPTION OF THE PREFERRED EMBODIMENT

Embodiments of the present circuit board assembly and projection system will now be described in detail below and with reference to the drawings.

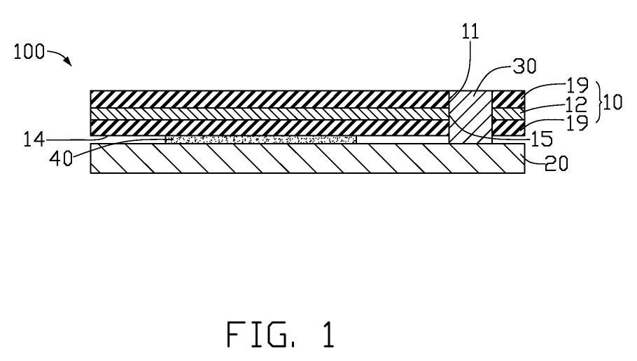

FIG. 1 illustrates a circuit board assembly 100, in accordance with a first preferred embodiment. The circuit board assembly 100 includes a circuit board 10, a reinforcing board 20, and at least one conductor 30. The circuit board 10 defines at least one hole 111 therein. Each conductor 30 is received in one respective hole 11. The circuit board 10 is electrically connected to the reinforcing board 20 via the at least one conductor 30. In the illustrated embodiment, the circuit board 10 defines one hole 11 with one conductor 30 received therein.

The circuit board 10 could, advantageously, be a printed circuit board, e.g., a flexible printed circuit board. The circuit board 10 includes a plurality of insulating layers 19 and at least one circuit pattern layer 12 sandwiched between adjacent insulating layers 19. In the illustrated embodiment, the circuit board 10 includes two insulating layers 19 and one circuit pattern layer 12 sandwiched between the two insulating layers 19.

Each insulating layer 19 could, e.g., be a polyimide layer, polymethyl methacrylate or polycarbonate. The circuit pattern layer 12 has a plurality of circuit pattern formed therein. The circuit pattern in the circuit pattern layer 12 has a conduct area 15 requiring a zero electric potential. The hole 11 extends through the conduct area 15 and the circuit board 10. Thus, the conduct area 15 of the circuit patter layer 12 surrounding the hole 11 is electrically connected to the reinforcing board 20 via the conductor 30.

The reinforcing board 20 is advantageously grounded to allow offending electrical charges and fields of the circuit pattern layer 12 to be dissipated out. The reinforcing board 20 could be made of a hard conductive material, e.g., copper, iron, steel, or a combination thereof.

The conductor 30 essentially consists of metal and, advantageously, is made of tin or tin alloy. The hard conductive material of the reinforcing board 20 is advantageously a metal or alloy readily soldering with the conductor 30.

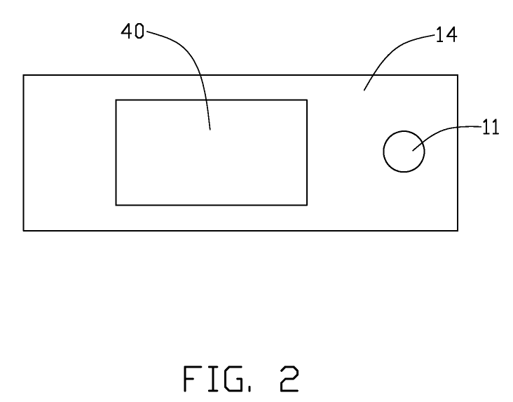

The circuit board 10 has a non-hole region 14 surrounding the hole 11. A bonding layer 40 is, beneficially, adhered to the non-hole region 14, as show in FIG. 2. The reinforcing board 20 is attached to the circuit board 10 via the bonding layer 40. The bonding layer 40 could, e.g., be a curable adhesive or paste. For example, the bonding layer 40 could be an antisotropic conductive paste (ACP), an antisotropic conductive film (ACF), silicone, epoxy, acrylic, or polyamide adhesive. Alternatively, the bonding layer 40 could be replaced by any other appropriate fixing means such as, for example, metallurgical means.

The method for manufacturing the circuit board assembly 100 includes the following steps: providing a circuit board 10 and a reinforcing board 20, the circuit board 10 having one hole 11 formed therein, one solder being received in the hole 11, the solder essentially consisting of metal, the reinforcing board 20 being attached to the circuit board 10 with the hole 11 facing towards the reinforcing board 20; and heating and cooling the solder in the hole 11 to form a conductor 30 electrically connecting the circuit board 10 to the reinforcing board 20.

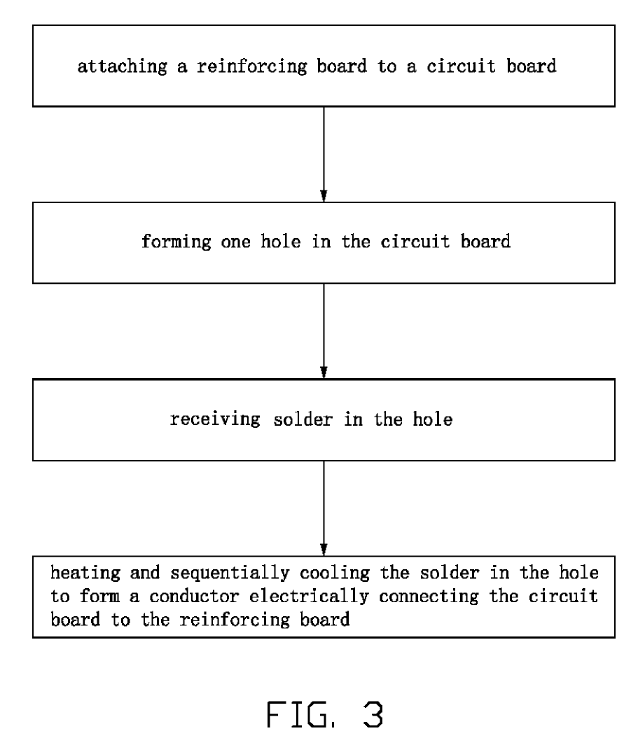

FIG. 3 illustrates an exemplary manufacturing method of the circuit board assembly 100. In the illustrated embodiment, the exemplary manufacturing method includes the following steps: attaching the reinforcing board 20 to the circuit board 10; forming one hole 11 in the circuit board 10; receiving solder in the hole 11; and heating and cooling the solder in the hole 11 to form a conductor 30 electrically connecting the circuit board 10 to the reinforcing board 20. The reinforcing board 20 could be attached to the circuit board 10, for example, via the bonding layer 40, as shown in FIG. 2. The hole 11 is formed on the circuit board 10 by a punching method, for example such as a mechanical punching method or a laser punching method.

The solder is advantageously made of tin or tin alloy. When filled into the hole 11, the solder is typically in solid state. The solder beneficially protrudes out of the hole 11 and contacts the reinforcing board 20. Thus, after heating and sequentially cooling the solder to form a conductor 30, the conductor 30 is sintered together with the circuit board 10 and the reinforcing board 20. Accordingly, the circuit board 10 is electrically connected to the reinforcing board 20 via the conductor 30. The circuit board assembly 100 is thereby obtained.

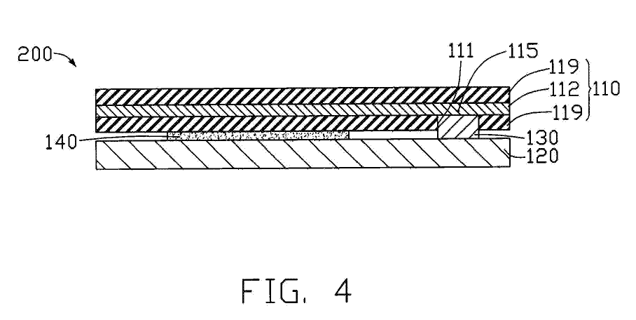

FIG. 4 illustrates a circuit board assembly 200, in accordance with a second preferred embodiment. The circuit board assembly 200 includes a circuit board 110, a reinforcing board 120, a bonding layer 140 bonding the reinforcing board 120 to the circuit board 110, and a conductor 130, which are respectively essentially similar to the circuit board 10, the reinforcing board 20, and the conductor 30 of the circuit board assembly 100.

The circuit board 110 defines a hole 111 different from the hole 11 in the circuit board 10. The hole 111 is a blind hole. For example, the blind hole 111 passes through the insulating layer 119 adjacent to the reinforcing board 120. A conduct point 115, requiring a zero electrical, of the circuit patter layer 112 is exposed towards the blind hole 111. The conductor 130 is received in the blind hole 111. The conductor 130 is electrically connected to the conduct point 115 of the circuit board 110 and the reinforcing board 120.

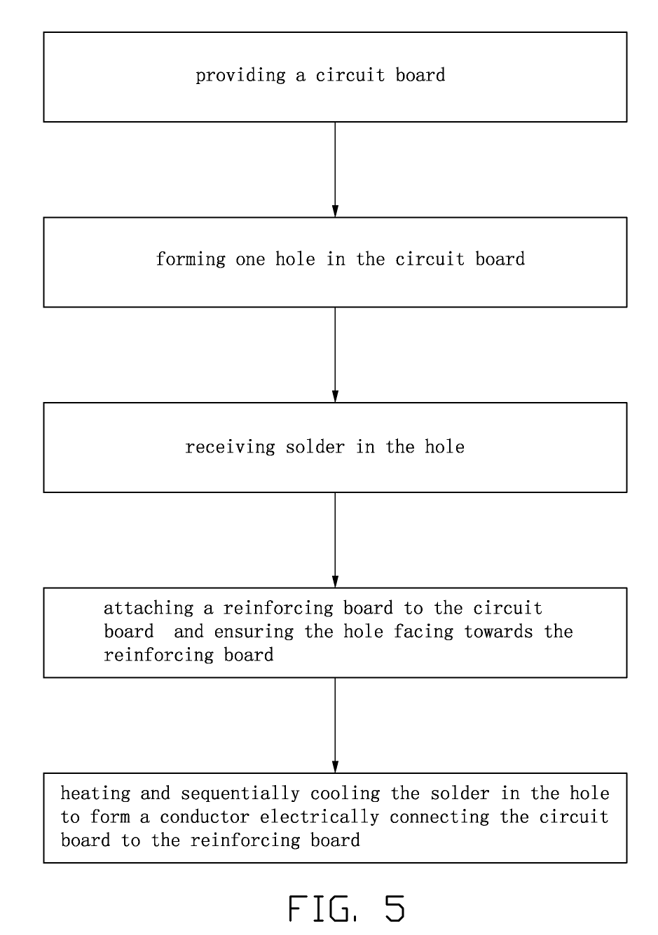

The manufacturing method of the circuit board assembly 200 is essentially similar to that of circuit board assembly 100, except for the providing of the circuit board 110 and the reinforcing board 120. FIG. 5 illustrates an exemplary manufacturing method of the circuit board assembly 200. The manufacturing method includes the following steps: providing a circuit board 110; forming one hole 111 in the circuit board 110; receiving solder in the hole 111; attaching a reinforcing board 120 to the circuit board 110 and ensuring that the hole 111 faces towards the reinforcing board 110; and heating and sequentially cooling the solder to form a conductor 130 electrically connecting the circuit board 110 to the reinforcing board 120.

The forming method of the hole 111 is essentially similar to that of the hole 10, except that the hole 111 is a blind hole. The insulating layer 119 adjacent to the reinforcing board 120 is punched through thereby forming the blind hole 111. The reinforcing board 120 is attached to the circuit board 110 via a bonding method, e.g., adhesive or paste. During attaching, the hole 111 in the circuit board 110 faces towards the reinforcing board 110. The solder preferably protrudes out of the hole 111 and thus contacts the reinforcing board 110 after attaching. The heating and sequentially cooling of this method in this embodiment is essentially similar to those of the method in the first preferred embodiment.

It is to be understood that the circuit board 110 could be punched into a through hole 111 extending through the circuit board 110. As a result, the circuit board assembly 100 in the first preferred embodiment could be made by this method.

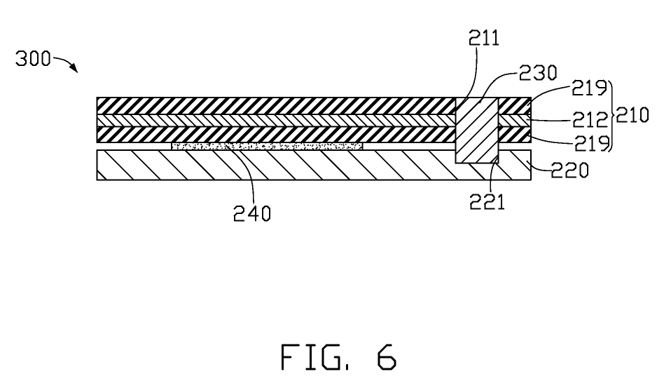

FIG. 6 illustrates a circuit board assembly 300, in accordance with a third preferred embodiment. The circuit board assembly 300 includes a circuit board 210, a reinforcing board 220, a conductor 230, and a bonding layer 240. The circuit board 210, the conductor 230, and the bonding layer 240 are, respectively, essentially similar to the circuit board 10, the conductor 30, and the bonding layer 40 of the circuit board assembly 100. The circuit board 210 defines a hole 211 extending through the circuit board 210, for receiving the conductor 230.

The reinforcing board 220 is essentially similar to the reinforcing board 20 of the circuit board assembly 100, except that the reinforcing board 220 defines a cavity 221. The cavity 221 corresponds to the hole 230. The conductor 230 beneficially protrudes out of the hole 211 and extends into the cavity 221. Thus, two ends of the conductor 230 are respectively received in the hole 211 and the cavity 221, accordingly increasing electrical conduct between the conductor 230 and the reinforcing board 220. The cavity 221 could, e.g., be a groove. Alternatively, the cavity 211 could be a through aperture extending through the reinforcing board 220.

The circuit board assembly 300 could be made by a method, e.g., the manufacturing method of the circuit board assembly 100 in the first preferred embodiment. The cavity 221 could, e.g., be sequentially formed in the reinforcing board 220 after forming of the hole 211 in the circuit board 210. That is, the hole 211 and the cavity 221 could be sequentially formed, e.g., by a successive punching process, along a common axial direction of the hole and the cavity. Alternatively, the hole 211 and the cavity 221 may be formed at the same time. Then, the solder is received in the hole 211 and the cavity 221. After heating and sequentially cooling of the solder to form the conductor 230, the conductor 230 is electrically connected to the circuit board 210 and the reinforcing board 220. The circuit board assembly 300 is thereby obtained.

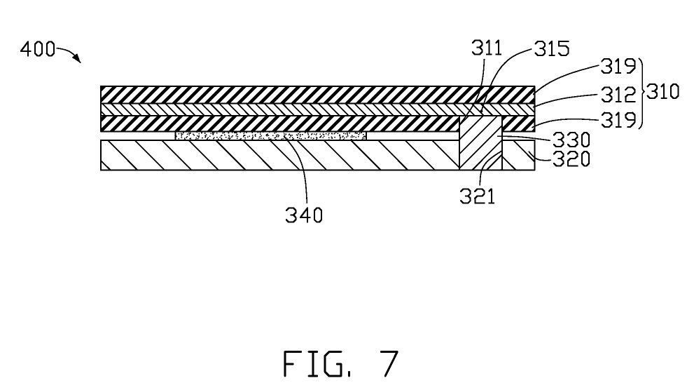

FIG. 7 illustrates a circuit board assembly 400, in accordance with a fourth preferred embodiment. The circuit board assembly 400 includes a circuit board 310, a reinforcing board 320, a conductor 330, and a bonding layer 340. The circuit board 310, the conductor 330, and the bonding layer 340 are essentially similar to the circuit board 110, the conductor 130, and the bonding layer 140 of the circuit board assembly 200, respectively. The circuit board 310 defines a hole 311 exposing a conduct area 315 requiring zero electrical potential.

The reinforcing board 320 is essentially similar to the reinforcing board 220 of the circuit board assembly 300, except of a cavity 321 defined therein. In this embodiment, the cavity 321 is defined through the reinforcing board 320. Two ends of the conductor 330 are, advantageously, received in the hole 311 and the cavity 321, respectively. Accordingly, the circuit board 310 is electrically connected to the reinforcing board 320. Alternatively, the reinforcing board 320 could be essentially similar to the reinforcing board 220. That is, the cavity 321 could be a groove corresponding to the hole 311.

The circuit board assembly 400 could be made by a method, e.g., the manufacturing method of the circuit board assembly 200 in the second preferred embodiment, except for the cavity 321. The cavity 321 could, e.g., be formed by sequentially punching through the reinforcing board 320 after forming of the hole 311 in the circuit board 310. Then, the solder is received in the hole 311 and the cavity 321. After heating and sequentially cooling of the solder to form the conductor 330, the conductor 330 is electrically connected to the circuit board 310 and the reinforcing board 320. The circuit board assembly 400 is thereby obtained.

Alternatively, the circuit board assembly 400 could be made by the following steps: attaching the reinforcing board 320 to the circuit board 310; forming the cavity 321 in the reinforcing board 320 and then the hole 311 in the circuit board 310; receiving solder in the hole 311 and the cavity 321; and heating and cooling the solder in the hole 311 and the cavity 321 to form the conductor 330 electrically connecting the circuit board 310 to the reinforcing board 320.

In the alternative method, the attaching step, the receiving step, and the heating and sequentially cooling step are essentially similar to those of the manufacturing method of the circuit board assembly 100 in the first preferred embodiment, as show in FIG. 3. The hole 311 is formed by sequentially punching the circuit board 310 after forming of the cavity 321 in the reinforcing board 320. The hole 211 and the cavity 321 could be sequentially formed, e.g., by a successive punching process along a common axial of the hole and the cavity.

It is to be understood that the circuit board could define two or more holes, respectively corresponding to the conduct areas requiring zero electrical potential. Each hole could, e.g., be one of the holes 11, 111, 211, 311. Each hole receives one of the conductors 30, 130, 230, 330.

In the embodiments above mentioned, each conductor can electrically connects the circuit board with the reinforcing board. The conductor can provide sufficient electronic conduct between the circuit board and the reinforcing board. When the circuit pattern layer generates offending electrical charges and fields, the reinforcing board grounded would allow the offending electrical charges and fields to be dissipated out. Thus, the circuit board assembly has an effective shielding against EMI.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A circuit board assembly comprising:
a circuit board having at least one hole formed therein;
at least one conductor being received in the at least one hole, the at least one conductor essentially consisting of metal; and
a reinforcing board configured to be grounded, attached to the circuit board, the reinforcing board being electrically connected to the circuit board via the at least one metal conductor.

2. The circuit board assembly as claimed in claim 1, wherein the at least one hole is at least one through hole defined through the circuit board.

3. The circuit board assembly as claimed in claim 1, wherein the reinforcing board defines at least one cavity facing towards the at least one hole, the at least one conductor being received in the at least one cavity.

4. The circuit board assembly as claimed in claim 3, wherein the at least one cavity is at least one groove without extending through the reinforcing board or at least one through aperture extending through the reinforcing board.

5. The circuit board assembly as claimed in claim 3, wherein the at least one conductor comprises two ends respectively received in the at least one cavity and the at least one hole.

6. The circuit board assembly as claimed in claim 1, wherein the circuit board comprises a plurality of insulating layers and at least one circuit pattern layer being sandwiched between adjacent insulating layers, the at least one circuit pattern layer comprising at least one conduct area requiring a zero potential, the at least one hole extending through the at least one conduct area so as to connect the at least one conduct area to the reinforcing board via the at least one conductor.

7. The circuit board assembly as claimed in claim 6, wherein the at least one hole is a blind hole extending through one insulating layer adjacent to the reinforcing board, the blind hole exposing the conduct area so as to connect the exposed conduct area to the reinforcing board via the at least one conductor.

8. The circuit board assembly as claimed in claim 1, wherein the metal of the conductor is chosen from the group consisting of tin and tin alloys.

9. The circuit board assembly as claimed in claim 1, wherein a bonding layer is adhered between the circuit board and the reinforcing board, the bonding layer being separated from the conductor.

10. The circuit board assembly as claimed in claim 10, wherein the bonding layer is selected from the group consisting of curable adhesive and paste.

11. A method for making a circuit board assembly, the method comprising steps of:
providing a circuit board and a reinforcing board, the circuit board having at least one hole formed therein, at least one solder being received in the at least one hole, the at least one solder essentially consisting of metal, the reinforcing board being attached to the circuit board with the at least one hole facing towards the reinforcing board; and
heating and cooling the solder to form at least one conductor electrically connecting the circuit board with the reinforcing board.

12. The method as claimed in claim 11, wherein the first step comprises the following steps: providing a circuit board, forming at least one hole in the circuit board; receiving solder in the at least one hole; and attaching a reinforcing board to the circuit board with the at least one hole facing towards the reinforcing board.

13. The method as claimed in claim 11, wherein the first step comprises the following steps: attaching a reinforcing board to a circuit board; forming at least one hole in the circuit board; and receiving solder in the at least one hole providing a circuit board.

14. The method as claimed in claim 11, wherein the at least one hole is formed by one of a mechanical punching method and a laser punching method.

15. The method as claimed in claim 12, wherein the attaching step of the reinforcing board to the circuit board comprises steps of: forming at least one cavity in the reinforcing board corresponding to the at least one hole; and adhering the reinforcing board to the circuit board with the at least one cavity facing and aligning with the at least one hole.

16. The method as claimed in claim 15, further comprising a step of inserting solder into each cavity in the reinforcing board after the forming of the at least one cavity.

17. A circuit board assembly comprising:
a circuit board comprising a plurality of insulating layers and at least one circuit pattern layer sandwiched between adjacent two insulating layers, the circuit board defining at least one hole to expose the at least one circuit pattern layer;
an electricity conductive reinforcing board configured to be grounded, the reinforcing board being attached to one of the insulating layers of the circuit board via a bonding layer; and
at least one conductor separate from the bonding layer being received in the at least one hole and connecting the at least one circuit pattern layer with the reinforcing board. The circuit board as claimed in claim 21, wherein the at least one conductor is formed by heating and sequentially cooling solder filled in the at least one hole.

18. The circuit board as claimed in claim 17, wherein the reinforcing board defines at least one cavity configured for receiving the at least one conductor.

19. The circuit board as claimed in claim 17, wherein the at least one hole extends through the circuit board.

20. The circuit board as claimed in claim 17, wherein the bonding layer is made of curable adhesive or paste.
